(19) United States
(12) Patent Application Publication
(10) Pub. No.: US 2026/0274204 A1
(43) Pub. Date: Sep. 17, 2026

(54) INFORMATION MANAGEMENT APPARATUS, TERMINAL APPARATUS, NON-TRANSITORY COMPUTER-READABLE MEDIUM STORING A PROGRAM, AND INFORMATION MANAGEMENT METHOD

(71) Applicant: HONDA MOTOR CO., LTD., Tokyo (JP)

(72) Inventor: Ryo TAKEBAYASHI, Tokyo (JP)

(21) Appl. No.: 19/168,330

(22) PCT Filed: Mar. 29, 2023
(86) PCT No.: PCT/JP2023/012965

§ 371 Date: Sep. 24, 2025

(51) Int. Cl. B60R 25/24; B60R 25/01; G07C 9/00

(52) U.S. Cl. CPC B60R 25/24; B60R 25/01; G07C 9/00309; G07C 2009/00793

(57) ABSTRACT

An information management device according to an embodiment of the present invention comprises a communication unit, a determination unit, and a restriction unit. The communication unit communicates with a first terminal device used as a digital key for restricting and/or releasing restriction of at least one function of a machine. The determination unit determines whether a first user using the first terminal device satisfies a prescribed condition. If the prescribed condition is satisfied, the restriction unit puts the digital key in a restricted state in which the digital key is unable to restrict and/or release restriction of the function.

### TECHNICAL FIELD

The present invention relates to an information management apparatus, a terminal apparatus, a program, and an information management method.

### BACKGROUND ART

Patent Document 1 discloses a digital key system capable of accurately estimating a distance to a smartphone with respect to a vehicle.

In addition, there is a demand for a technique allowing a driver or an operator to safely drive or operate a mobile body, such as a vehicle or other machine.

### Citation List

### Patent Document

Patent Document 1: Japanese Unexamined Patent Application, Publication No. 2021-85719

### DISCLOSURE OF THE INVENTION

### Problems to be Solved by the Invention

An embodiment of the present invention aims to achieve an object to provide an information management apparatus, a terminal apparatus, a program, and an information management method capable of encouraging a driver or an operator of a machine to safely drive or operate the machine by means of a digital key system.

### Means for Solving the Problems

An information management apparatus according to an embodiment includes a communicator, a determiner, and a restrictor. The communicator communicates with a first terminal that is used as a digital key for restricting and/or derestricting at least one function of a machine. The determiner determines whether a first user who uses the first terminal satisfies a predetermined condition. The restrictor brings, in a case where the predetermined condition is satisfied, the digital key into a restricted state in which the digital key is unable to restrict and/or derestrict the at least one function.

### Effects of the Invention

The present invention is capable of encouraging a driver or an operator of a machine to safely drive or operate the machine.

### BRIEF DESCRIPTION OF THE DRAWINGS

FIG. 1 is a block diagram illustrating an example of a configuration of a digital key system according to an embodiment and main parts of components included in the digital key system;

FIG. 2 is a block diagram illustrating an example of a configuration of the digital key system according to the embodiment and main parts of components included in the digital key system;

FIG. 3 is a flowchart illustrating an example of processing performed by a processor of the server apparatus illustrated in FIG. 1;

FIG. 4 is a flowchart illustrating an example of processing performed by the processor of the server apparatus illustrated in FIG. 1;

FIG. 5 is a flowchart illustrating an example of processing performed by the processor of the server apparatus illustrated in FIG. 1;

FIG. 6 is a flowchart illustrating an example of processing performed by a processor of the key terminal apparatus illustrated in FIG. 1;

FIG. 7 is a flowchart illustrating an example of processing performed by the processor of the key terminal apparatus illustrated in FIG. 1;

FIG. 8 is a flowchart illustrating an example of processing performed by a processor of the control apparatus illustrated in FIG. 2;

FIG. 9 is a flowchart illustrating an example of processing performed by the processor of the control apparatus illustrated in FIG. 2; and

FIG. 10 is a flowchart illustrating an example of processing performed by a processor of the terminal apparatus illustrated in FIG. 2.

### PREFERRED MODE FOR CARRYING OUT THE INVENTION

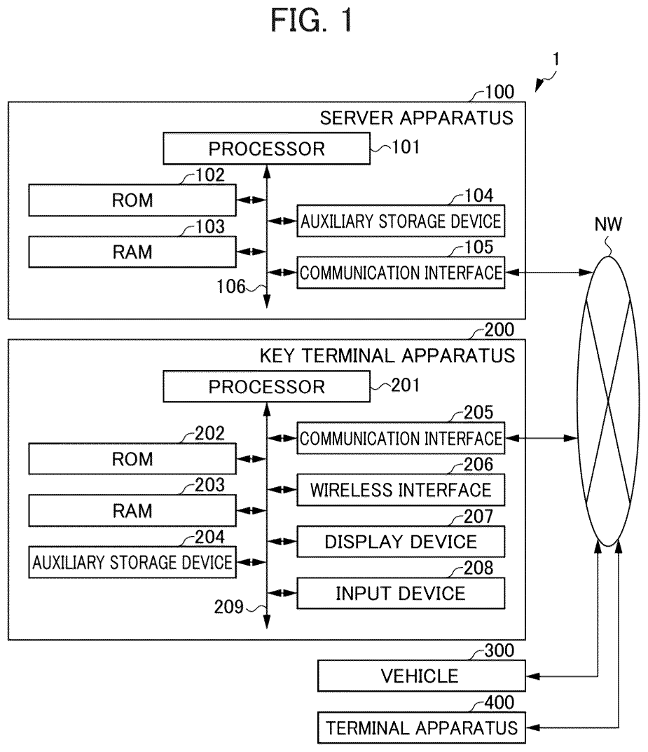

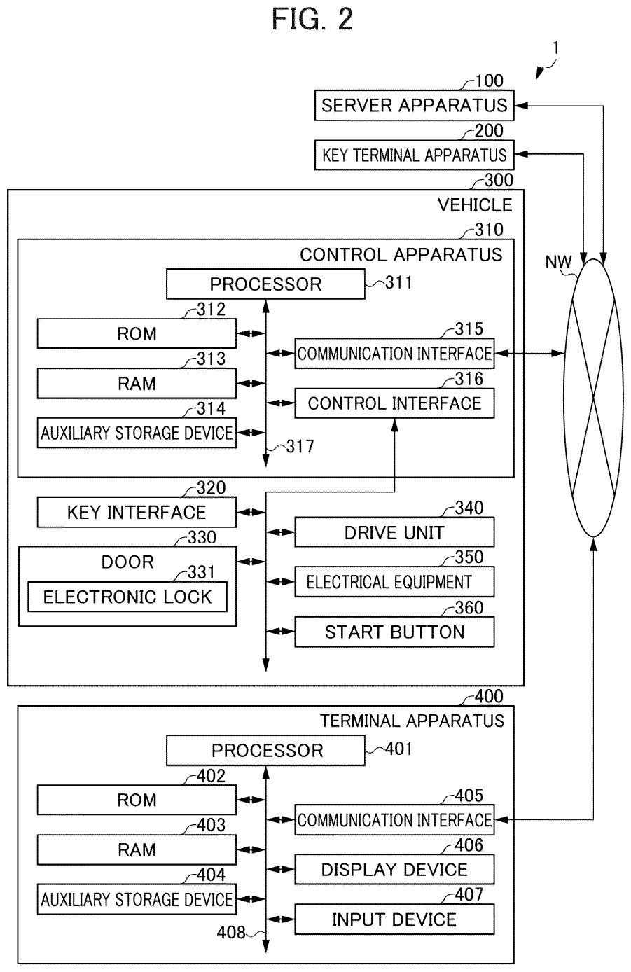

A digital key system according to an embodiment will be described below with reference to the drawings. In the drawings with reference to which the embodiment will be described, the scale of each component may be appropriately changed. In addition, the drawings with reference to which the embodiment will be described, some of components may be omitted for convenience of description. In the drawings and the specification, the same reference signs denote the same elements. FIGS. 1 and 2 are block diagrams illustrating an example of a configuration of a digital key system 1 according to the embodiment and main parts of components included in the digital key system 1. Each of the components of apparatuses may be internal or external. The digital key system 1 provides a digital key service. The digital key service enables a digital key to be used as a key for a vehicle. A digital key refers to a mobile electronic device, such as a smartphone, that has a communication function and can serve as a key. Furthermore, the digital key service is capable of restricting a function of the digital key when the predetermined condition is not satisfied. For example, the digital key system 1 includes a server apparatus 100, a key terminal apparatus 200, a vehicle 300, and a terminal apparatus 400. The digital key system 1 may include part of the foregoing elements. Although FIGS. 1 and 2 illustrate one server apparatus 100, one key terminal apparatus 200, one vehicle 300, and one terminal apparatus 400, the respective elements are not limited to any particular number.

The server apparatus 100, the key terminal apparatus 200, the vehicle 300, and the terminal apparatus 400 are connected to a network NW. The network NW is typically a communication network including the Internet. The network NW is typically a communication network including a wide area network (WAN). The network NW may be a communication network including a private network such as an intranet. The network NW may be a communication network including a dedicated line or a public mobile phone network.

The server apparatus 100 is a server for providing a digital key service. The server apparatus 100 manages various kinds of data used in the digital key service, controls the digital key, and the like. The server apparatus 100 may include, for example, a processor 101, a read-only memory (ROM) 102, a random-access memory (RAM) 103, an auxiliary storage device 104, and a communication interface 105. These components are connected to each other with a bus 106 or the like. The server apparatus 100 is an example of an information management apparatus.

The processor 101 is a central part of a computer that performs calculations, control, and the like necessary for the server apparatus 100 to operate, and performs various calculations, processing, and the like. The processor 101 may be, for example, a central processing unit (CPU), a micro processing unit (MPU), a system on a chip (Soc), a digital signal processor (DSP), a graphics processing unit (GPU), an application specific integrated circuit (ASIC), a programmable logic device (PLD), a field-programmable gate array (FPGA), or the like. Alternatively, the processor 101 is a combination of two or more of them. Alternatively, the processor 101 may be a combination of one or more of them and a hardware accelerator or the like. The processor 101 controls the components to implement various functions of the server apparatus 100 based on programs such as firmware, system software, and application software stored in the ROM 102, the auxiliary storage device 104, or the like. The processor 101 performs processing described later based on the programs. Part or all of the programs may be incorporated in a circuit of the processor 101.

The ROM 102 and the RAM 103 are main storage devices for the computer including the processor 101 as the central part. The ROM 102 is a nonvolatile memory exclusively used for reading data. The ROM 102 stores, for example, firmware among the above-described programs. The ROM 102 further stores data and the like that the processor 101 uses to perform various types of processing. The RAM 103 is a memory used for reading and writing data. The RAM 103 is used as a work area for storing data that the processor 101 temporarily uses to perform various types of processing. The RAM 103 is typically a volatile memory.

The auxiliary storage device 104 is an auxiliary storage device for the computer including the processor 101 as the central part. The auxiliary storage device 104 is, for example, an electric erasable programmable read-only memory (EEPROM), a hard disk drive (HDD), a flash memory, or the like. The auxiliary storage device 104 stores, for example, system software and application software among the above-described programs. In addition, the auxiliary storage device 104 stores data that the processor 101 uses to perform various types of processing, data generated by way of processing by the processor 101, various setting values, and the like.

The data stored in the auxiliary storage device 104 includes, for example, a user database (DB).

The user DB stores and manages information regarding a user who uses the digital key service. The user DB stores, for example, information regarding each user (hereinafter, referred to as “user information”) in association with a user identifier (ID). The user ID is identification information uniquely assigned to each user. The user information includes, for example, various settings (hereinafter, referred to as “key service settings”) relating to the digital key service, and a server restriction variable. A default value may be set for each setting included in the key service settings. The default value is determined in advance by, for example, a designer or administrator of the digital key system 1 or a seller of the vehicle 300. The key service settings may include a setting changeable by the user and a setting unchangeable by the user. The server restriction variable indicates whether the digital key of the user identified by the associated user ID is in a restricted state or an unrestricted state. The restricted state and the unrestricted state will be described later.

The communication interface 105 is an interface for the server apparatus 100 to communicate via the network NW or the like. The communication interface 105 functions as an example of a communicator that communicates with a first terminal. In addition, the communication interface 105 is an example of a communication device. The processor 101 functions as an example of a communication controller that controls and causes the communication device to communicate with the first terminal by controlling and causing the communication interface 105 to communicate with the first terminal.

The bus 106 includes a control bus, an address bus, a data bus, and the like, and transmits signals exchanged between the components of the server apparatus 100.

The key terminal apparatus 200 is a mobile electronic device that has a communication function and can serve as a digital key. The digital key can restrict and/or derestrict at least one function of the vehicle 300. The key terminal apparatus 200 is, for example, a general-purpose electronic device such as a smartphone, a tablet terminal, or a smart watch. Alternatively, the key terminal apparatus 200 may be an electronic device exclusively functioning as a digital key. For example, the key terminal apparatus 200 includes a processor 201, a ROM 202, a RAM 203, an auxiliary storage device 204, a communication interface 205, a wireless interface 206, a display device 207, and an input device 208. These components are connected to each other with a bus 209 or the like. The key terminal apparatus 200 is an example of the first terminal apparatus. The user of the key terminal apparatus 200 is an example of a first user who uses the first terminal.

The processor 201 is a central part of a computer that performs calculations, control, and the like necessary for the key terminal apparatus 200 to operate, and performs various calculations, processing, and the like. The processor 201 is, for example, a CPU, a MPU, a SOC, a DSP, a GPU, an ASIC, a PLD, a FPGA, or the like. Alternatively, the processor 201 is a combination of two or more of them. Alternatively, the processor 201 may be a combination of one or more of them and a hardware accelerator or the like. The processor 201 controls the components to implement various functions of the key terminal apparatus 200 based on programs such as firmware, system software, and application software stored in the ROM 202, the auxiliary storage device 204, or the like. The processor 201 performs processing described later based on the programs. Part or all of the programs may be incorporated in a circuit of the processor 201.

The ROM 202 and the RAM 203 are main storage devices for the computer including the processor 201 as the central part. The ROM 202 is a nonvolatile memory exclusively used for reading data. The ROM 202 stores, for example, firmware among the above-described programs. The ROM 202 further stores data and the like that the processor 201 uses to perform various types of processing. The RAM 203 is a memory used for reading and writing data. The RAM 203 is used as a work area for storing data that the processor 201 temporarily uses to perform various types of processing. The RAM 203 is typically a volatile memory.

The auxiliary storage device 204 is an auxiliary storage device for the computer including the processor 201 as the central part. The auxiliary storage device 204 is, for example, an EEPROM, a HDD, a flash memory, or the like. The auxiliary storage device 204 stores, for example, system software and application software among the above-described programs. In addition, the auxiliary storage device 204 stores data that the processor 201 uses to perform various types of processing, data generated by way of processing by the processor 201, various setting values, and the like. The auxiliary storage device 204 is an example of a storage.

The application software stored in the auxiliary storage device 204 includes a key application. The key application is application software for using a digital key service. The key application is application software that enables the key terminal apparatus 200 to function as a digital key. The processor 201 downloads the key application via, for example, the communication interface 205. The processor 201 installs the downloaded key application. Alternatively, the key application may be preinstalled in the key terminal apparatus 200.

In order to cause the key terminal apparatus 200 to function as a digital key, it is necessary to register key information in the key application. The key application uses the key information to release the vehicle 300 from a locked state. The key application transmits the key information to the vehicle 300 so that authentication is performed using the key information. The key information is unique to each combination of the vehicle 300 to be used and a user who uses the vehicle 300. Registering a plurality of pieces of key information enables the key application to release a plurality of vehicles 300 corresponding to the respective pieces of key information from the locked state. Furthermore, an expiration date may be set for the key information. In this case, the key information is valid until the expiration date.

The key application includes a restriction variable. The restriction variable indicates whether the digital key operated by the key application is in a restricted state or an unrestricted state. The restricted state and the unrestricted state will be described later.

In order to use part or all of the digital key service, login to the digital key service is needed. The key terminal apparatus 200 logs in to the digital key service using, for example, the user ID. The processor 201 may automatically perform the login or may perform the login in response to an operation by the operator of the key terminal apparatus 200. The key terminal apparatus 200 stores the user ID used for the login. This user ID is hereinafter referred to as a “login ID”.

The communication interface 205 is an interface for the key terminal apparatus 200 to communicate via the network NW or the like.

The wireless interface 206 is an interface for the key terminal apparatus 200 to wirelessly communicate with the vehicle 300. The wireless interface 206 includes an antenna or the like for wireless communication.

The display device 207 displays a screen for notifying various kinds of information to the operator of the key terminal apparatus 200. The display device 207 is, for example, a display such as a liquid crystal display, an organic electro-luminescence (EL) display, or the like.

The input device 208 receives an operation by the operator of the key terminal apparatus 200. The input device 208 is, for example, a keyboard, a keypad, a touch pad, a mouse, a controller, or the like. The input device 208 may be a device for voice input. A touch panel can be used as the display device 207 and the input device 208. In this case, a display panel of the touch panel functions as the display device 207. A pointing device implemented by touch input via the touch panel functions as the input device 208.

The bus 209 includes a control bus, an address bus, a data bus, and the like, and transmits signals exchanged between the components of the key terminal apparatus 200.

The vehicle 300 is, for example, an automobile. The vehicle 300 includes, for example, a control apparatus 310, a key interface 320, a door 330, a drive unit 340, electrical equipment 350, and a start button 360.

The control apparatus 310 performs various controls on the vehicle 300, for example. The control apparatus 310 has a function of authenticating key information read from the key terminal apparatus 200. The control apparatus 310 further has a function of releasing the vehicle 300 from a locked state and bringing the vehicle 300 into an unlocked state upon authenticating valid key information. When the vehicle 300 is in the locked state, an electronic lock 331 (to be described later) of the vehicle 300 is locked, and the components of the vehicle 300 including the drive unit 340 and the electrical equipment 350 cannot be started. The locked state is an example of a state in which a lock is set so that the vehicle 300 cannot be driven. The locked state is an example of a state in which at least one function of the vehicle 300 is restricted. When the vehicle 300 in the unlocked state, the electronic lock 331 is unlocked, and the components of the vehicle 300 including the drive unit 340 and the electrical equipment 350 can be started. The control apparatus 310 is, for example, an electronic control unit (ECU) or the like. The control apparatus 310 includes, for example, a processor 311, a ROM 312, a RAM 313, an auxiliary storage device 314, a communication interface 315, and a control interface 316. These components are connected to each other with a bus 317 or the like.

The processor 311 is a central part of a computer that performs calculations, control, and the like necessary for the vehicle 300 to operate, and performs various calculations, processing, and the like. The processor 311 is, for example, a CPU, a MPU, a SoC, a DSP, a GPU, an ASIC, a PLD, or a FPGA. Alternatively, the processor 311 is a combination of two or more of them. Alternatively, the processor 311 may be a combination of one or more of them and a hardware accelerator or the like. The processor 311 controls the components to implement various functions of the vehicle 300 based on programs such as firmware, system software, and application software stored in the ROM 312, the auxiliary storage device 314, or the like. The processor 311 performs processing described later based on the programs. Part or all of the programs may be incorporated in a circuit of the processor 311.

The ROM 312 and the RAM 313 are main storage devices for the computer including the processor 311 as the central part. The ROM 312 is a nonvolatile memory exclusively used for reading data. The ROM 312 stores, for example, firmware among the above-described programs. The ROM 312 further stores data and the like that the processor 311 uses to perform various types of processing. The RAM 313 is a memory used for reading and writing data. The RAM 313 is used as a work area for storing data that the processor 311 temporarily uses to perform various types of processing. The RAM 313 is typically a volatile memory.

The auxiliary storage device 314 is an auxiliary storage device for the computer including the processor 311 as the central part. The auxiliary storage device 314 is, for example, an EEPROM, a HDD, a flash memory, or the like. The auxiliary storage device 314 stores, for example, system software and application software among the above-described programs. In addition, the auxiliary storage device 314 stores data that the processor 311 uses to perform various types of processing, data generated by way of the processing by the processor 311, various setting values, and the like.

The data stored in the auxiliary storage device 314 includes a vehicle ID and vehicle setting information of the vehicle 300, which is equipped with the auxiliary storage device 314. The vehicle ID is identification information uniquely assigned to each vehicle 300. The vehicle setting information includes settings related to the operation of the vehicle 300, among the settings related to the digital key service. A default value may be set for each setting included in the vehicle setting information. The default value is determined by, for example, a designer or administrator of the key system 1 or a seller of the vehicle 300 in advance. The vehicle setting information may include a setting changeable by a user and a setting unchangeable by the user.

The communication interface 315 is an interface for the vehicle 300 to communicate via the network NW or the like.

The control interface 316 is an interface for the control apparatus 310 to communicate with the components of the vehicle 300. The control apparatus 310 controls the components of the vehicle 300 via the control interface 316. The components include, for example, the key interface 320, the door 330, the drive unit 340, the electrical equipment 350, and the start button 360.

The bus 317 includes a control bus, an address bus, a data bus, and the like, and transmits signals exchanged between the components of the control apparatus 310.

The key interface 320 is an interface for wirelessly communicating with the key terminal apparatus 200, which functions as the digital key. The key interface 320 includes an antenna or the like for wireless communication.

The door 330 is a door through which a person gets into and out of the vehicle 300. The door 330 is, for example, a door that allows a person to get to and leave the driver's seat, which is a place for driving the vehicle 300. The door 330 is provided with the electronic lock 331.

The electronic lock 331 can be unlocked by the digital key.

The drive unit 340 includes parts and equipment for the vehicle 300 to travel. The drive unit 340 is, for example, a power unit, a battery, a drive system, or the like. The power unit is, for example, an engine or a motor.

The electrical equipment 350 includes electrical system components and appliances. The electrical equipment 350 includes, for example, a car air conditioner, an in-vehicle Wi-Fi, an in-vehicle entertainment, a car audio system, an in-vehicle display, a car navigation system, an in-vehicle device, in-vehicle instruments, and the like.

The start button 360 is a button operated to start part or all of the drive unit 340 and the electrical equipment 350.

The terminal apparatus 400 enables browsing of various kinds of information related to the digital key service, change of various settings, and the like. The terminal apparatus 400 is, for example, a personal computer (PC), a tablet terminal, a smartphone, or the like. The terminal apparatus 400 may be the key terminal apparatus 200. The terminal apparatus 400 includes, for example, a processor 401, a ROM 402, a RAM 403, an auxiliary storage device 404, a communication interface 405, a display device 406, and an input device 407. These components are connected to each other with a bus 408. The terminal apparatus 400 is an example of a second terminal apparatus. The user of the terminal apparatus 400 is an example of a second user who uses the second terminal.

The terminal apparatus 400 stores therein application software including a browsing application. The browsing application is application software that allows the user to browse various kinds of information related to the digital key service and to change various settings. The browsing application may be general-purpose application software such as a web browser, or may be application software dedicated to the digital key system 1.

The terminal apparatus 400 logs in to the digital key service in the same manner as the key terminal apparatus 200. The terminal apparatus 400 stores the login ID.

The processor 401 is a central part of a computer that performs calculations, control, and the like necessary for the terminal apparatus 400 to operate, and performs various calculations, processing, and the like. The processor 401 is, for example, a CPU, a MPU, a SOC, a DSP, a GPU, an ASIC, a PLD, a FPGA, or the like. Alternatively, the processor 401 is a combination of two or more of them. Alternatively, the processor 401 may be a combination of one or more of them and a hardware accelerator or the like. The processor 401 controls the components to implement various functions of the terminal apparatus 400 based on programs such as firmware, system software, and application software stored in the ROM 402, the auxiliary storage device 404, or the like. The processor 401 performs processing described later based on the programs. Part or all of the programs may be incorporated in a circuit of the processor 401.

The ROM 402 and the RAM 403 are main storage devices for the computer including the processor 401 as the central unit. The ROM 402 is a nonvolatile memory exclusively used for reading data. The ROM 402 stores, for example, firmware among the above-described programs. The ROM 402 further stores data and the like that the processor 401 uses to perform various types of processing. The RAM 403 is a memory used for reading and writing data. The RAM 403 is used as a work area for storing data that the processor 401 temporarily uses to perform various types of processing. The RAM 403 is typically a volatile memory.

The auxiliary storage device 404 is an auxiliary storage device for the computer having the processor 401 as the central part. The auxiliary storage device 404 is, for example, an EEPROM, a HDD, a flash memory, or the like. The auxiliary storage device 404 stores, for example, system software and application software among the above-described programs. In addition, the auxiliary storage device 404 stores data that the processor 401 uses to perform various types of processing, data generated by way of the processing by the processor 401, various setting values, and the like.

The communication interface 405 is an interface for the terminal apparatus 400 to communicate via the network NW or the like.

The display device 406 displays a screen for providing notification of various kinds of information to the operator of the terminal apparatus 400. The display device 406 is, for example, a display such as a liquid crystal display, an organic EL display, or the like.

The input device 407 receives an operation by the operator of the terminal apparatus 400. The input device 407 is, for example, a keyboard, a keypad, a touch pad, a mouse, a controller, or the like. The input device 407 may be a device for voice input. A touch panel can be used as the display device 406 and the input device 407. In this case, a display panel of the touch panel functions as the display device 406. A pointing device implemented by touch input via the touch panel functions as the input device 407.

The bus 408 includes a control bus, an address bus, a data bus, and the like, and transmits signals exchanged between the components of the terminal apparatus 400.

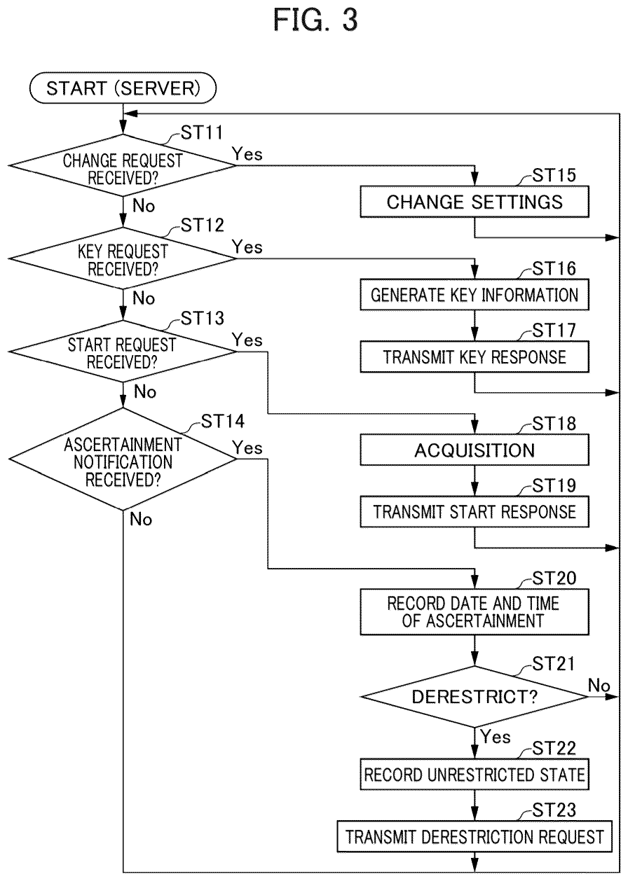

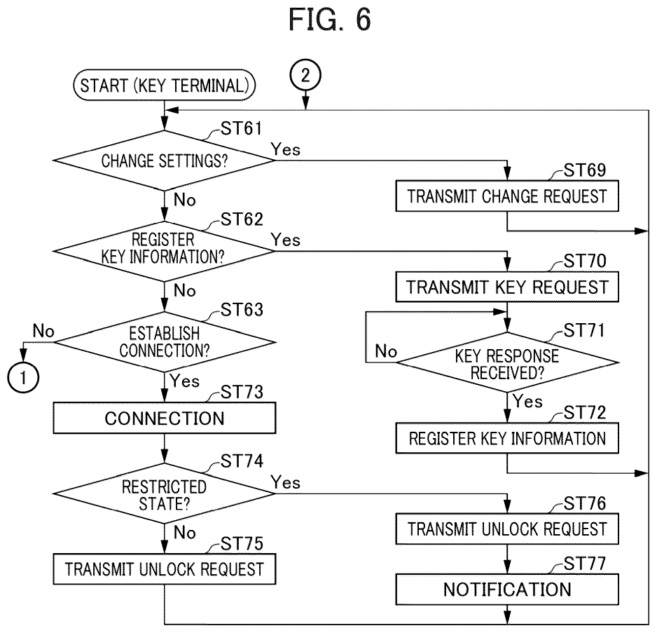

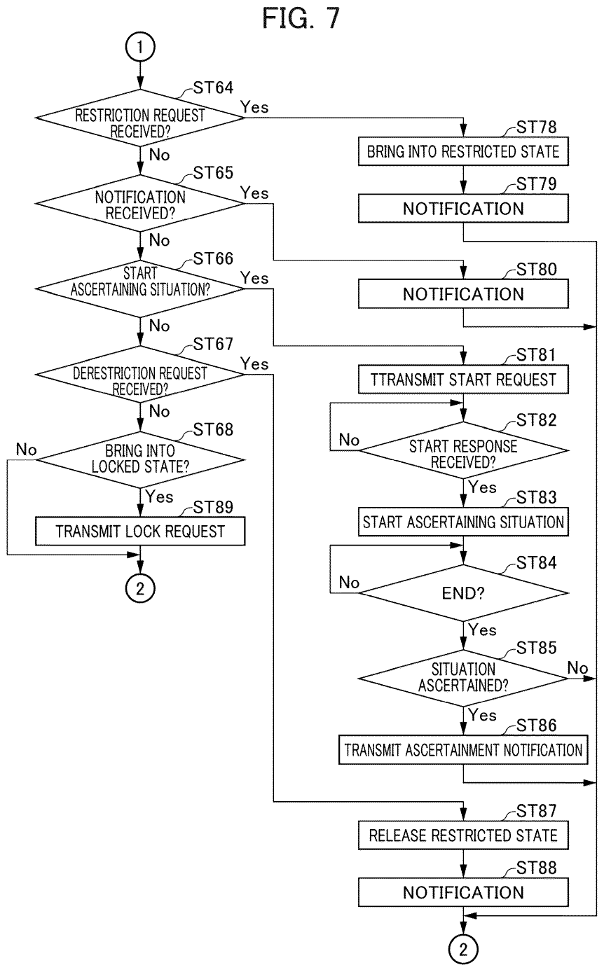

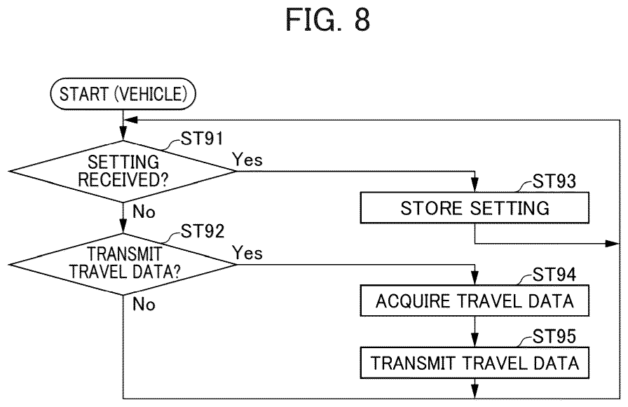

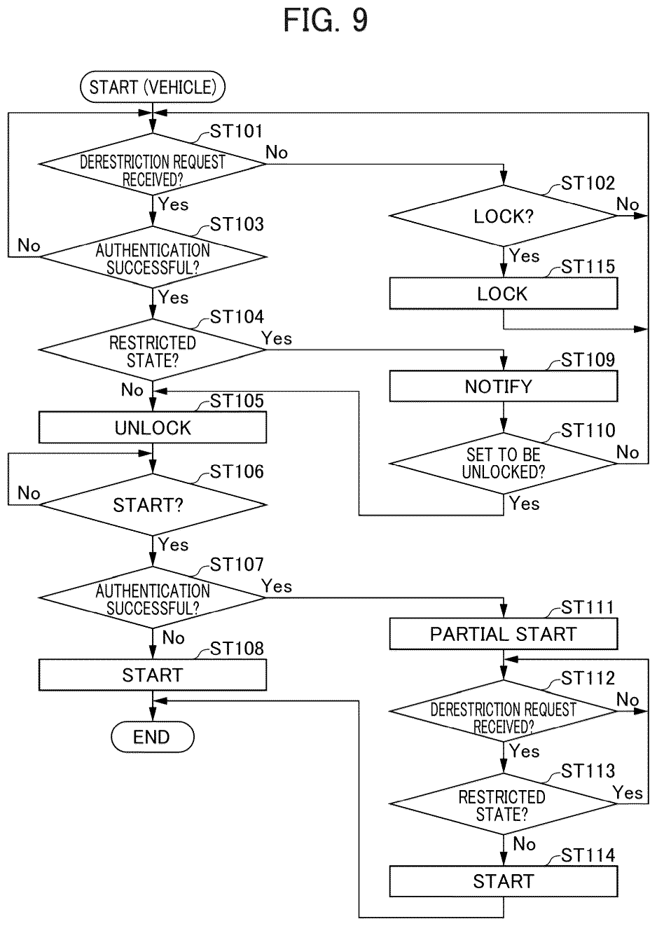

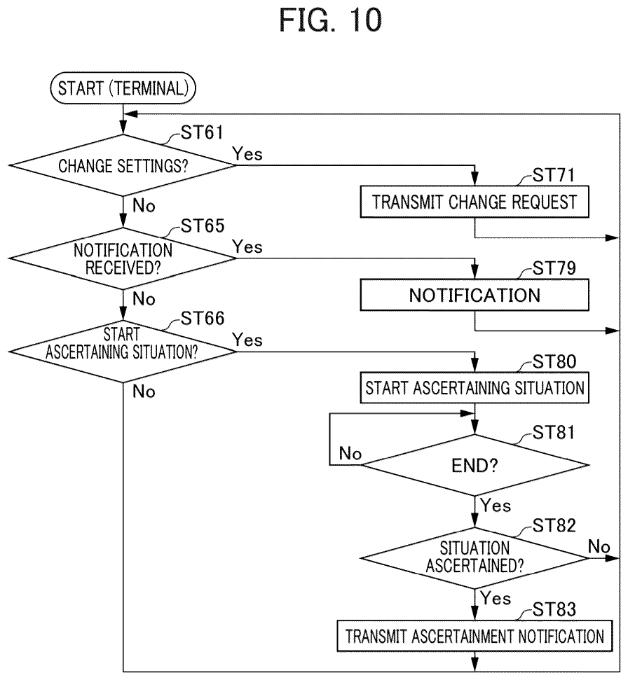

The following describes operation of the digital key system 1 according to the embodiment with reference to FIGS. 3 to 10, etc. It should be noted that the contents of the processing involved in the operation described below are non-limiting examples, and various types of processing capable of achieving similar results can be used as appropriate. FIGS. 3 to 5 are flowcharts illustrating examples of processing performed by the processor 101 of the server apparatus 100. The processor 101 performs the processing illustrated in FIGS. 3 to 5 based on, for example, the programs stored in the ROM 102, the auxiliary storage device 104, or the like. For example, the processor 101 performs the processing illustrated in FIGS. 3 to 5 in parallel or concurrently. FIGS. 6 and 7 are flowcharts illustrating examples of processing performed by the processor 201 of the key terminal apparatus 200. The processor 201 performs the processing illustrated in FIGS. 6 and 7 based on, for example, the programs stored in the ROM 202, the auxiliary storage device 204, or the like. FIGS. 8 and 9 are flowcharts illustrating examples of processing performed by the processor 311 of the control apparatus 310. The processor 311 performs the processing illustrated in FIGS. 8 and 9 based on, for example, the programs stored in the ROM 312, the auxiliary storage device 314, or the like. For example, the processor 311 executes the processing illustrated in FIGS. 8 and 9 in parallel or concurrently. FIG. 10 is a flowchart illustrating an example of processing performed by the processor 401 of the terminal apparatus 400. The processor 401 performs the processing illustrated in FIG. 10 based on, for example, the programs stored in the ROM 402, the auxiliary storage device 404, or the like.

In Step ST61 in FIG. 6, the processor 201 of the key terminal apparatus 200 determines whether or not to change the key service settings. When the processor 201 does not determine to change the key service settings, it determines “No” in Step ST61 and proceeds to Step ST62.

In Step ST62, the processor 201 determines whether or not to newly register key information. When the processor 201 does not determine to newly register the key information, it determines “No” in Step ST62 and proceeds to Step ST63.

In Step ST63, the processor 201 determines whether or not to establish connection to the key interface 320. When the processor 201 does not determine to establish the connection to the key interface 320, it determines “No” in Step ST63 and proceeds to Step ST64.

In Step ST64, the processor 201 determines whether or not a restriction request has been received by the communication interface 205. If the restriction request has not been received, the processor 201 determines “No” in Step ST64 and proceeds to Step ST65.

In Step ST65, the processor 201 determines whether or not notification information has been received by the communication interface 205. If the notification information has not been received, the processor 201 determines “No” in Step ST65 and proceeds to Step ST66.

In Step ST66, the processor 201 determines whether or not to start ascertaining a driving situation. When the processor 201 does not determine to start ascertaining the driving situation, it determines “No” in Step ST64 and proceeds to Step ST67.

In Step ST67, the processor 201 determines whether or not a derestriction request has been received by the communication interface 205. If the derestriction request has not been received, the processor 201 determines “No” in Step ST67 and proceeds to Step ST68.

In Step ST68, the processor 201 determines whether or not to bring the vehicle 300 into the locked state. For example, the processor 201 determines that the vehicle 300 should be brought into the locked state in a case where an operation to bring the vehicle 300 into the locked state has been performed using the input device 208. When the processor 201 does not determine to bring the vehicle 300 into the locked state, it determines “No” in Step ST68 and returns to Step ST61. Thus, the processor 201 goes into a standby state in which the processor 201 repeats Steps ST61 to ST68 in FIGS. 6 and 7 until it determines that the vehicle 300 should be brought into the locked state: the processor 201 repeatedly determines whether or not to change the key service settings, whether or not to newly register the key information, whether or not to establish connection to the key interface 320, whether or not to start ascertaining the driving situation, whether or not the restriction request has been received, whether or not the notification information has been received, and whether or not the derestriction request has been received. The notification information, the restriction request, and the derestriction request will be described later.

When desiring to change the key service settings, the operator of the key terminal apparatus 200 inputs a to-be-changed content of the key service settings by operating, for example, the input device 208. The processor 201 determines to change the key service settings in accordance with the input.

In the case where the processor 201 determines to change the key service settings while being in the standby state in which the processor 201 repeats Steps ST61 to ST68 in FIGS. 6 and 7, the processor 201 determines “Yes” in Step ST61 in FIG. 6 and proceeds to Step ST69.

In Step ST69, the processor 201 generates a change request. The change request includes, for example, a login ID and change information. The change information indicates the to-be-changed content of the key service settings. After generating the change request, the processor 201 instructs the communication interface 205 to transmit the change request to the server apparatus 100. In response to this transmission instruction, the communication interface 205 transmits the change request to the server apparatus 100. The transmitted change request is received by the communication interface 105 of the server apparatus 100. After performing the processing of Step ST69, the processor 201 returns to Step ST61.

On the other hand, in Step ST11 in FIG. 3, the processor 101 of the server apparatus 100 determines whether or not the change request has been received by the communication interface 105. If the change request has not been received, the processor 101 determines “No” in Step ST11, and proceeds to Step ST12.

In Step ST12, the processor 101 determines whether or not a key request has been received by the communication interface 105. If the key request has not been received, the processor 101 determines “No” in Step ST12 and proceeds to Step ST13.

In Step ST13, the processor 101 determines whether or not a start request has been received by the communication interface 105. If the start request has not been received, the processor 101 determines “No” in Step ST13 and proceeds to Step ST14.

In Step ST14, the processor 101 determines whether or not an ascertainment notification has been received by the communication interface 105. If the ascertainment notification has not been received, the processor 101 determines “No” in Step ST14 and returns to Step ST11. Thus, the processor 101 goes into a standby state in which the processor 101 repeats Steps ST11 to ST14 until the change request, the key request, the start request, or the ascertainment notification is received. The key request, the start request, and the ascertainment notification will be described later.

In the case where the change request is received while the processor 101 is in the standby state in which the processor 101 repeats Steps ST11 to ST14, the processor 101 determines “Yes” in Step ST11 and proceeds to Step ST15.

In Step ST15, the processor 101 changes the key service settings by updating the user DB based on the change request received in Step ST11. Specifically, the processor 101 changes a key service setting associated with the user ID included in the change request, in accordance with the change information included in the change request.

In a case where the to-be-changed content of the key service settings includes a content that requires a change in the operation of the vehicle 300, the processor 101 generates setting information. The setting information indicates a setting content for changing the operation of the vehicle 300. After generating the setting information, the processor 101 instructs the communication interface 105 to transmit the setting information to the control apparatus 310. In response to this transmission instruction, the communication interface 105 transmits the setting information to the control apparatus 310. The transmitted setting information is received by the communication interface 315 of the control apparatus 310. After performing the processing of Step ST15, the processor 101 returns to Step ST11.

On the other hand, in Step ST91 in FIG. 8, the processor 311 of the control apparatus 310 determines whether or not the setting information has been received by the communication interface 315. If the setting information has not been received, the processor 311 determines “No” in Step ST91 and proceeds to Step ST92.

In Step ST92, the processor 311 determines whether or not to transmit travel data. When the processor 311 does not determine to transmit the travel data, it determines “No” in Step ST92 and returns to Step ST91. Thus, the processor 311 goes into a standby state in which the processor 311 repeats Steps ST91 and ST92 until the setting information is received or the processor 311 determines to transmit the travel data. The travel data will be described later.

In the case where the setting information is received while the processor 311 is in the standby state in which the processor 311 repeats Steps ST91 and ST92, the processor 311 determines “Yes” in Step ST91 and proceeds to Step ST93.

In Step ST93, the processor 311 updates the vehicle setting information in accordance with the setting information received in Step ST91. After performing the processing of Step ST93, the processor 311 returns to Step ST91.

When desiring to newly register key information in the key application, the operator of the key terminal apparatus 200 performs an input for instructing the key terminal apparatus 200 to newly register the key information by a predetermined method. For example, the processor 201 determines to newly register a digital key in response to the input instructing to newly register the key information.

In the case where the processor 201 determines to newly register a digital key while being in the standby state in which the processor 201 repeats Steps ST61 to ST68 in FIGS. 6 and 7, the processor 201 determines “Yes” in Step ST62 and proceeds to Step ST70 in FIG. 6.

In Step ST70, the processor 201 generates a key request. The key request includes target information. The key request is information requesting transmission of key information specified by the target information. The target information is information capable of specifying a vehicle 300 set as the target by the key information and a user who uses the key information. After generating the key request, the processor 201 instructs the communication interface 205 to transmit the key request to the server apparatus 100. In response to this transmission instruction, the communication interface 205 transmits the key request to the server apparatus 100. The transmitted key request is received by the communication interface 105 of the server apparatus 100.

On the other hand, in the case where the key request is received while the processor 101 of the server apparatus 100 is in the standby state in which the processor 101 repeats Steps ST11 to ST14 in FIG. 3, the processor 101 determines “Yes” in Step ST12 and proceeds to Step ST16.

In Step ST16, the processor 101 generates key information in accordance with the target information included in the key request received in Step ST12.

In Step ST17, the processor 101 generates a key response. The key response includes the key information generated in Step ST16. The key response is, for example, information instructing registration of the key information. After generating the key response, the processor 101 instructs the communication interface 105 to transmit the key response to the key terminal apparatus 200 from which the key request has been transmitted. In response to this transmission instruction, the communication interface 105 transmits the key response to the key terminal apparatus 200. The transmitted key response is received by the communication interface 205 of the key terminal apparatus 200. After performing the processing of Step ST17, the processor 101 returns to Step ST11.

On the other hand, in Step ST71 in FIG. 6, the processor 201 of the key terminal apparatus 200 waits for the key response to be received by the communication interface 205. In response to reception of the key response, the processor 201 determines “Yes” in Step ST71 and proceeds to Step ST72.

In Step ST72, the processor 201 registers, in the key application, the key information included in the key response received in Step ST71. At this time, the processor 201 stores the key information in the auxiliary storage device 204. After performing the processing of Step ST72, the processor 201 returns to Step ST61.

For example, in a case where the distance between the key terminal apparatus 200 and the key interface 320 become equal to or less than a predetermined distance, the processor 201 determines to establish connection to the key interface 320. For example, in a case where a radio wave transmitted from the key interface 320 is received, the processor 201 determines to connect to establish connection to the key interface 320. For example, in a case where communication with the key interface 320 becomes possible, the processor 201 determines to establish connection to the key interface 320. For example, in response to a touch of a person who is holding the key terminal apparatus 200 on the door 330, the processor 201 determines to establish connection to the key interface 320.

In the case where the processor 201 determines to establish connection to the key interface 320 while being in the standby state in which the processor 201 repeats Steps ST61 to ST68 in FIGS. 6 and 7, the processor 201 determines “Yes” in Step ST63 and proceeds to Step ST73 of FIG. 6.

In Step ST73, the processor 201 establishes communication between the wireless interface 206 and the key interface 320.

In Step ST74, the processor 201 determines whether or not the digital key is in the restricted state. If the digital key is not in the restricted state, that is, if the digital key is in the unrestricted state, the processor 201 determines “No” in Step ST74 and proceeds to Step ST75. The restricted state and the unrestricted state will be described later.

In Step ST75, the processor 201 generates an unlock request. The unlock request is information requesting releasing the vehicle 300 from the locked state of. The unlock request includes, for example, the login ID, the restriction variable stored in the auxiliary storage device 204, and the key information registered in the key application. The value of the restriction variable indicates the unrestricted state. After generating the unlock request, the processor 201 instructs the wireless interface 206 to transmit the unlock request to the vehicle 300. In response to this transmission instruction, the wireless interface 206 transmits the unlock request to the vehicle 300. The transmitted unlock request is received by the key interface 320 of the vehicle 300. After performing the processing in Step ST75, the processor 201 returns to Step ST61.

As described above, by performing the processing of Step ST63 and Steps ST73 to ST75 in FIG. 6, the processor 201 of the key terminal apparatus 200 functions as an example of a digital key unit that causes the first terminal to function as a digital key.

For example, the processor 311 of the control apparatus 310 starts the processing illustrated in FIG. 9 in response to the vehicle 300 being brought into the locked state. In Step ST101 in FIG. 9, the processor 311 of the control apparatus 310 determines whether or not the unlock request has been received by the key interface 320. If the unlock request has not been received, the processor 311 determines “No” in Step ST101 and proceeds to Step ST102.

In Step ST102, the processor 311 determines whether or not to bring the vehicle 300 into the locked state. When the processor 311 does not determine to bring the vehicle 300 into the locked state, the processor 311 determines “No” in Step ST102 and returns to Step ST101. Thus, the processor 311 goes into a standby state in which the processor 311 repeats Steps ST101 and ST102 until the unlock request is received or the processor 311 determines to bring the vehicle 300 into the locked state.

In the case where the unlock request is received while the processor 311 is in the standby state in which the processor 311 repeats Steps ST101 and ST102, the processor 311 determines “Yes” in Step ST101 and proceeds to Step ST103.

In Step ST103, the processor 311 performs authentication using the key information included in the unlock request received in Step ST101. The processor 311 then determines whether or not the authentication has been successful. If the authentication has not been successful, the processor 311 determines “No” in Step ST103 and returns to Step ST101. On the other hand, if the authentication has been successful, the processor 311 determines “Yes” in Step ST103 and proceeds to Step ST104.

In Step ST104, the processor 311 refers to the restriction variable included in the unlock request received in Step ST101, and determines whether or not the digital key is in the restricted state. If the digital key is not in the restricted state, the processor 311 determines “No” in Step ST104 and proceeds to Step ST105.

In Step ST105, the processor 311 controls and unlocks the electronic lock 331. As a result, the person who is holding the key terminal apparatus 200 is allowed to get into the vehicle 300. When the person or another in the vehicle 300 wants to start the components of the vehicle 300, such as the drive unit 340, the person or the other performs an operation of starting the vehicle 300, such as operating the start button 360, for example.

In Step ST106, the processor 311 waits for the operation of starting the vehicle 300 to be performed. That is, the processor 311 waits for a predetermined operation such as operating the start button 360. In response to the operation of starting the vehicle 300 being performed, the processor 311 determines “Yes” in Step ST106 and proceeds to Step ST107.

In Step ST107, the processor 311 refers to the restriction variable included in the unlock request received in Step ST101, and determines whether or not the digital key is in the restricted state. If the digital key is not in the restricted state, the processor 311 determines “No” in Step ST107 and proceeds to Step ST108.

In Step ST108, the processor 311 starts the components of the vehicle 300. After performing the processing of Step ST108, the processor 311 ends the processing illustrated in FIG. 9.

The vehicle 300 has a function of recording travel data for each driver. The driver of the vehicle 300 is identified by the user ID included in the unlock request received in Step ST101 in FIG. 9. The control apparatus 310 uses, for example, various sensors and thereby records travel data. The travel data includes, for example, a travel route, a history of speed, a history of acceleration, a history of jerk, a history of brake opening degree, a history of brake timing, a history of sudden braking, a history of accelerator opening degree, a history of accelerator timing, a history of steering angle, a history of steering timing, a history of deviation from travel lane, a history of operation of collision reducing brake, a history of failure to stop at stop sign, a history of failure to obey traffic sings at intersection, etc., a history of violating slow driving at intersection, etc., a history of running in wrong direction, a history of overspeed, excess in overspeed, information indicating whether or not each road on the travel route is an expressway, information indicating whether or not the driver recognized road signs that must be checked during traveling, a history of the driver's drowsing, and a health state of the driver. In addition, the vehicle 300 has a function of transmitting the travel data to the server apparatus 100. The control apparatus 310 transmits the travel data at a predetermined timing, for example. The predetermined timing is, for example, a periodic timing. Alternatively, the predetermined timing is a timing at which the driver finished driving the vehicle 300. Alternatively, the predetermined timing is a timing at which the vehicle 300 was brought into the locked state. The processor 311 of the control apparatus 310 determines to transmit the travel data in response to the predetermined timing being reached.

In the case where the processor 311 determines to transmit the travel data while being in the standby state in the processor 311 repeats Steps ST91 and ST92 in FIG. 8, the processor 311 determines “Yes” in Step ST92 and proceeds to Step ST94.

In Step ST94, the processor 311 acquires, from among pieces of the travel data of the driver specified by the user ID included in the unlock request received in Step ST101 in FIG. 9, a piece that has not yet been transmitted.

In Step ST95 in FIG. 8, the processor 311 generates travel data information. The travel data information includes the travel data acquired in Step ST94 and the user ID included in the unlock request received in Step ST101 in FIG. 9. After generating the travel data information, the processor 311 instructs the communication interface 315 to transmit the travel data information to the server apparatus 100. In response to this transmission instruction, the communication interface 315 transmits the travel data information to the server apparatus 100. The transmitted travel data information is received by the communication interface 105 of the server apparatus 100. After performing the processing of Step ST95, the processor 311 returns to Step ST91.

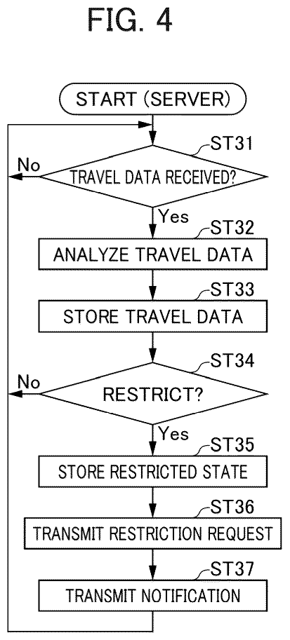

On the other hand, in Step ST31 in FIG. 4, the processor 101 of the server apparatus 100 waits for the travel data information to be received by the communication interface 105. In response to reception of the travel data information, the processor 101 determines “Yes” in Step ST31 and proceeds to Step ST32.

In Step ST32, the processor 101 performs an analysis of the travel data included in the travel data information received in Step ST31. This analysis includes a diagnosis of the driving situation. The processor 101 may also perform the analysis using the travel data stored in the user DB in the past.

The processor 101 acquires the travel data by controlling and causing the communication interface 105 to receive the travel data information. The processor 101 acquires the results of the analysis of the travel data by performing the processing in Step ST32. Therefore, by receiving the travel data information and/or performing the processing of Step ST32, the processor 101 functions as an example of an acquirer that acquires information indicating an operation situation of a machine by the first user.

In Step ST33, the processor 101 stores in the user DB the travel data included in the travel data information received in Step ST31 and the analysis results obtained in Step ST32 in association with the user ID included in the travel data information.

Therefore, by performing the processing of Step ST33 in cooperation with the auxiliary storage device 104, the processor 101 functions as an example of a storage that stores the operation situation. Alternatively, by performing the processing of Step ST33 by controlling the auxiliary storage device 104, the processor 101 functions as an example of the storage.

In Step ST34, based on the travel data and the analysis results obtained in Step ST32, the processor 101 determines whether or not to bring the digital key used by a user in a restricted state. The user is identified by the user ID included in the travel data information received in Step ST31. For example, in a case of determining that the user's traveling has a problem to the extent that the digital key should be restricted, the processor 101 determines to bring the digital key into the restricted state. Examples of the case where there is a problem to the extent that the digital key should be restricted include: a case where the number of times of sudden braking is equal to or greater than a predetermined number of times; a case where the number of times of deviation from traveling lane is equal to or greater than a predetermined number of times; a case where the number of times of actuation of collision reduction brake is equal to or greater than a predetermined number of times; a case where the number of times of failure to stop at stop sign is equal to or greater than a predetermined number of times; a case where the number of times of failure to obey traffic sings at intersection, etc. is equal to or greater than a predetermined number of times; a case where the number of times of violating slow driving at intersection, etc. is equal to or greater than a predetermined number of times; a case where the number of times of running in wrong direction is equal to or greater than a predetermined number of times; a case where the number of times of overspeed is equal to or greater than a predetermined number of times; a case where an excess in overspeed is equal to or greater than a predetermined value; a case where a use frequency of expressways is within a predetermined frequency range; a case where the number of times the driver did not recognized road signs that must be checked during traveling is equal to or more than a predetermined number of times, a case where a frequency or duration of the driver's drowsing is equal to or greater than a predetermined frequency or duration, a case where a frequency of driving is less than a predetermined frequency, a case where it is determined that the driver is in a bad health state, a case where any other abnormal or dangerous driving is detected, and similar cases. In addition, when determining that the user is not driving safely, the processor 101 may access that there is a problem to the extent that the digital key should be restricted. When the processor 101 does not determine to bring the digital key into the restricted state, it determines “No” in Step ST34 and returns to Step ST31. On the other hand, when the processor 101 determines to bring the digital key into the restricted state, it determines “Yes” in Step ST34 and proceeds to Step ST35.

As described above, by performing the processing of Step ST34, the processor 101 functions as an example of a determiner that determines that the first user who uses the first terminal satisfies a predetermined condition. The situation in which there is a problem to the extent that the digital key should be restricted is an example of a situation in which there is a problem in operation by the first user. Therefore, the predetermined condition in Step ST34 is that there is a problem in the first user's driving.

In Step ST35, the processor 101 updates the user DB to set the value of the server restriction variable associated with the user ID included in the travel data information received in Step ST31 to a value indicating the restricted state. The processor 101 updates the user DB to reset the date and time when each user last ascertained the driving situation specified by the user ID. The date and time of ascertainment of the driving situation will be described later.

In Step ST36, the processor 101 instructs the communication interface 105 to transmit a restriction request to the key terminal apparatus 200 that is used by the user identified by the user ID included in the travel data information received in Step ST31. The restriction request is information instructing to bring the digital key into the restricted state. In response to the transmission instruction, the communication interface 105 transmits the restriction request to the key terminal apparatus 200. The transmitted restriction request is received by the communication interface 205 of the key terminal apparatus 200. After performing the processing of Step ST36, the processor 101 returns to Step ST31.

As described above, by performing the processing of transmitting the restriction request, the processor 101 functions as an example of a restrictor that, in the case where the predetermined condition is satisfied, brings the digital key into the restricted state in which the digital key is unable to unlock at least a portion of the lock of the machine. Alternatively, by transmitting the restriction request in cooperation with the communication interface 105, the processor 101 functions as an example of the restrictor.

On the other hand, in a case where the restriction request is received while the processor 201 of the key terminal apparatus 200 is in the standby state in which the processor 201 repeats Steps ST61 to ST68 in FIGS. 6 and 7, the processor 201 determines “Yes” in Step ST64 and proceeds to Step ST78 in FIG. 7.

In Step ST78, the processor 201 brings the digital key into the restricted state. To this end, the processor 201 rewrites the value of the restriction variable to a value indicating the restricted state.

As described above, by performing the processing of Step ST78 in response to reception of the restriction request and in cooperation with the auxiliary storage device 204, the processor 201 functions as an example of a restriction storage that stores therein information indicating that the digital key is in the restricted state in accordance with the control by the restrictor. Alternatively or additionally, by performing the processing of Step ST78 in response to reception of the restriction request, the processor 201 functions as an example of the restriction storage that causes a storage device to store information indicating that the digital key is in the restricted state in accordance with the control by the restrictor.

In Step ST79, in order to notify the person who is holding the key terminal apparatus 200 that the digital key has been brought into the restricted state, the processor 201 issues a notification to that effect. For example, the processor 201 causes the display device 207 to display an image indicating that the digital key is in the restricted state and that the restricted state is cancelled if the driving state is ascertained. Alternatively or additionally, the processor 201 may issue the notification by outputting sound from a speaker, causing a light-emitting device to emit light, causing a vibrator to vibrate, and a similar means. Alternatively or additionally, the processor 201 may issue the notification by a push notification. After performing the processing of Step ST79, the processor 201 returns to Step ST61 in FIG. 6.

A user of the digital key service can ascertain a driving situation of the vehicle 300 by the user or another user. The driving situation is based on the travel data and the analysis results stored in Step ST33.

The digital key system 1 has a function of restricting the digital key used by a user (hereinafter referred to as the “driving user” for distinction) in a case where the driving situation of the driving user has not been ascertained by a user specified in advance (hereinafter referred to as the “prespecified user” for distinction) within a predetermined period P1. The predetermined period P1 is, for example, a period from a past predetermined time to the current time. The predetermined time is determined in the form of a length of time, an arbitrary number of days, weeks, months, or years, or the like. The driving user and the prespecified user may be the same or different. A user is set as the prespecified user by way of the key service settings of the driving user. For example, a family member or an employer of the driving user is assumed to be set as the prespecified user. There may be a plurality of prespecified users. In the case where there are a plurality of prespecified users, the prespecified users may or may not include the driving user. In the case where there are a plurality of prespecified users, the digital key system 1 restricts the digital key, for example, when none of the prespecified users has ascertained the driving situation within the predetermined period P1. Alternatively, in the case where there are a plurality of prespecified users, the digital key system 1 restricts the digital key when at least N of the prespecified users have not ascertained the driving situation within the predetermined period P1. N is an integer equal to or greater than 1 and less than the number of prespecified users. The condition for restricting the digital key in the case where there are a plurality of prespecified users is determined by way of, for example, the key service settings of the driving user. The condition for restricting the digital key in the case where there is one prespecified user is that the driving situation has not been ascertained by the one prespecified user within the predetermined period P1. In the following, satisfaction of the condition for restricting the digital key due to the prespecified user's failure to ascertain the driving situation of the driving user within the predetermined period P1 is referred to as “the failure to ascertain the driving situation within the time period”. The length of the predetermined period P1 is determined by, for example, the key service settings of the driving user. The predetermined period P1 is an example of a first predetermined period.

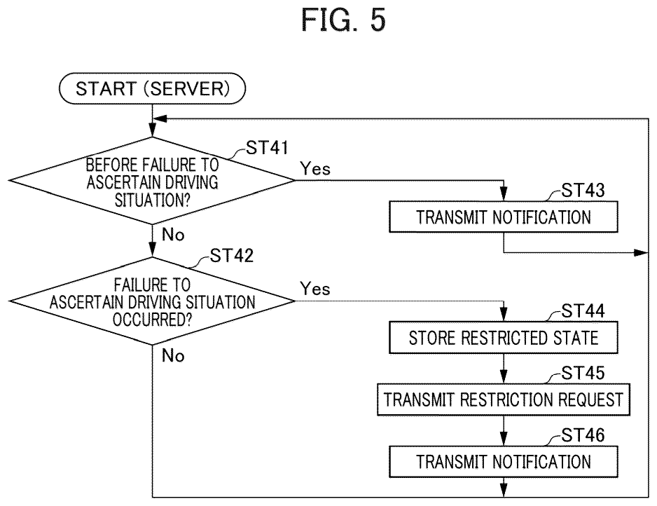

In Step ST41 in FIG. 5, the processor 101 of the server apparatus 100 determines whether or not there is a driving user for whom a remaining time until the failure to ascertain the driving situation within the time period occurs is equal to or shorter than a predetermined period P2. The processor 101 makes this determination with reference to the user DB, for example. The user DB stores, for each driving user, the date and time when the prespecified user last ascertained the driving situation. If there is no driving user for whom the remaining time until the failure to ascertain the driving situation within the time period occurs is equal to or shorter than the predetermined period P2, the processor 101 determines “No” in Step ST41 and proceeds to Step ST42.

In Step ST42, the processor 101 determines whether or not there is a driving user for whom the failure to ascertain the driving situation within the time period has occurred. The processor 101 makes this determination with reference to the user DB, for example. If there is no driving user for whom the failure to ascertain the driving situation within the time period has occurred, the processor 101 determines “No” in Step ST42 and returns to Step ST41. Thus, the processor 101 goes into a standby state in which the processor 101 repeats Steps ST41 and ST42 until a remaining time until the failure to ascertain the driving situation within the time period occurs becomes equal to or shorter than the predetermined period P2 or the failure to ascertain the driving situation within the time period occurs.

In the case where the processor 101 determines that there is a driving user for whom the remaining time until the failure to ascertain the driving situation within the time period occurs has become equal to or shorter than the predetermined period P2 while the processor 101 is in the standby state in which the processor 101 repeats Steps ST41 and ST42, the processor 101 determines “Yes” in Step ST41 and proceeds to Step ST43.

In Step ST43, the processor 101 instructs the communication interface 105 to transmit first notification information to the key terminal apparatus 200 used by the driving user for whom the remaining time until the failure to ascertain the driving situation within the time period occurs has become equal to or shorter than the predetermined period P2 and to the terminal apparatus 400 used by a prespecified user who pertains to the driving user and is not the driving user. The first notification information indicates that the failure to ascertain the driving situation within the time period is likely to occur. The first notification information is a type of notification information. In response to the transmission instruction, the communication interface 105 transmits the first notification information to the key terminal apparatus 200 and the terminal apparatus 400. The transmitted first notification information is received by the communication interface 205 of the key terminal apparatus 200. The transmitted first notification information is received by the communication interface 405 of the terminal apparatus 400. After performing the processing of Step ST43, the processor 101 returns to Step ST41.

A period until the period during which the driving situation has not been ascertained exceeds the predetermined period P1 is not longer than the predetermined period P2 is an example of a second predetermined period. This is expressed in the form of an equation: (second predetermined period)=(predetermined period P1)−(predetermined period P2). As described above, by performing the processing of Steps ST41 and ST43, the processor 101 functions as an example of a notification controller that causes the first terminal to notify that the predetermined condition is likely to be satisfied, in the case where a remaining time until an amount of time during which the first user has not ascertained the driving situation becomes equal to the first predetermined period or longer is equal to or shorter than the second predetermined period.

On the other hand, in the case where the notification information is received while the processor 201 of the key terminal apparatus 200 is in the standby state in which the processor 201 repeats Steps ST61 to ST68 in FIGS. 6 and 7, the processor 201 determines “Yes” in Step ST65 and proceeds to Step ST80 in FIG. 7.

In Step ST80, in order to notify the contents indicated by the notification information, the processor 201 issues a notification to that effect. For example, the processor 201 causes the display device 207 to display an image indicating that the failure to ascertain the driving situation within the time period is likely to occur. Alternatively or additionally, the processor 201 may issue the notification by outputting sound from a speaker, causing a light-emitting device to emit light, causing a vibrator to vibrate, and a similar means. Alternatively or additionally, the processor 201 may issue the notification by a push notification. After performing the processing of Step ST80, the processor 201 returns to Step ST61 in FIG. 6.

As illustrated in FIG. 10, the processor 401 of the terminal apparatus 400 performs processing the same as a part of the processing illustrated in FIGS. 6 and 7 performed by the processor 201 of the key terminal apparatus 200. The part includes Steps ST61, ST65, ST66, ST69, and ST80 to ST84. The following describes the processing illustrated in FIG. 10 performed by the processor 401 of the terminal apparatus 400, while omitting a description of the same part as the processing in FIGS. 6 and 7 performed by the processor 201 of the key terminal apparatus 200. However, note that the processing in FIG. 10 performed by the processor 401 is the same as the processing in FIGS. 6 and 7 except that the “key terminal apparatus 200” is replaced with the “terminal apparatus 400”, the “processor 201” with the “processor 401”, the “communication interface 205” with the “communication interface 405”, the “display device 207” with the “display device 406”, and the “input device 208” with the “input device 407”.

When determining “No” in Step ST61 in FIG. 10, the processor 401 of the terminal apparatus 400 proceeds to Step ST65. When determining “No” in Step ST66, the processor 401 returns to Step ST61. Thus, the processor 401 goes into a standby state in which the processor 401 repeats Steps ST61, ST65, and ST66 in FIG. 10 until it determines that ascertainment of the driving situation should be started: the processor 401 repeatedly determines whether or not to change the key service settings and whether or not the notification information has been received.

On the other hand, in the case where the processor 101 of the server apparatus 100 determines that there is a driving user for whom the failure to ascertain the driving situation within the time period has occurred while the processor 101 is in the standby state in which the processor 101 repeats Steps ST41 and ST42 in FIG. 5, the processor 101 determines “Yes” in Step ST42 and proceeds to Step ST44.

In Step ST44, the processor 101 updates the user DB to set the value of the server restriction variable associated with the user ID of the driving user for whom the failure to ascertain the driving situation within the time period has occurred to a value indicating the restricted state.

In Step ST45, the processor 101 instructs the communication interface 105 to transmit a restriction request to the key terminal apparatus 200 used by the driving user for whom the failure to ascertain the driving situation within the time period has occurred. In response to this transmission instruction, the communication interface 105 transmits the restriction request to the key terminal apparatus 200. The transmitted restriction request is received by the communication interface 205 of the key terminal apparatus 200.

As described above, by performing the processing of Step ST42, the processor 101 functions as an example of a determiner that determines whether the predetermined condition is satisfied by the first user who uses the first terminal functioning as the digital key for releasing the lock that prevents operation of the machine. The predetermined condition in Step ST42 in the case where the driving user is the prespecified user is that the first user has not ascertained the driving situation for the first predetermined period or longer. The predetermined condition in Step ST42 in the case where a user other than the driving user is the prespecified user is that the second user has not ascertained the driving situation for the first predetermined period or longer.

In Step ST46, the processor 101 instructs the communication interface 105 to transmit second notification information to the terminal apparatus 400 used by the prespecified user who pertains to the driving user for whom the failure to ascertain the driving situation within the time period has occurred and who is not the driving user. The second notification information indicates that the failure to ascertain the driving situation within the time period has occurred. The second notification information is a type of notification information. In response to the transmission instruction, the communication interface 105 transmits the second notification information to the terminal apparatus 400. The transmitted second notification information is received by the communication interface 405 of the terminal apparatus 400. After performing the processing of Step ST46, the processor 101 returns to Step ST41.

After performing the processing of Step ST36 in FIG. 4, the processor 101 proceeds to Step ST37. In Step ST37, the processor 101 instructs the communication interface 105 to transmit the second notification information to the terminal apparatus 400 used by the prespecified user who pertains to the driving user for whom the failure to ascertain the driving situation within the time period has occurred and who is not the driving user. In response to this transmission instruction, the communication interface 105 transmits the second notification information to the terminal apparatus 400. The transmitted second notification information is received by the communication interface 405 of the terminal apparatus 400.

When the operator of the key terminal apparatus 200 wants to ascertain the driving situation, for example, the operator performs, via the input device 208, an input indicating that the ascertainment of the driving situation is to be started. The processor 201 of the key terminal apparatus 200 determines to start the ascertainment of the driving situation in response to the input, for example.

In the case where the processor 201 of the key terminal apparatus 200 determines to start the ascertainment of the driving situation while being in the standby state in which the processor 201 repeats Steps ST61 to ST68 in FIGS. 6 and 7, the processor 201 determines “Yes” in Step ST66 and proceeds to Step ST81 of FIG. 7.

In Step ST81, the processor 201 generates a start request. The start request includes, for example, a login ID and a target ID. The target ID indicates a user whose driving situation to start to be ascertained. The target ID is the user ID of the user. Here, the target ID is the same as the login ID. The start request is information indicating that the ascertainment of driving situation is to be started. The start request is information for requesting transmission of information necessary for the ascertainment of the driving situation of the user identified by the target ID. After generating the start request, the processor 201 instructs the communication interface 205 to transmit the start request to the server apparatus 100. In response to this transmission instruction, the communication interface 205 transmits the start request to the server apparatus 100. The transmitted start request is received by the communication interface 105 of the server apparatus 100.

When the operator of the terminal apparatus 400 wants to ascertain the driving situation, for example, the operator performs, via the input device 407, an input indicating that the ascertainment of the driving situation is to be started. In addition, the operator of the terminal apparatus 400 performs an input for designating a user whose driving condition is to be ascertained, via the input device 407. Here, it is possible to designate a driving user whose login ID identifies a prespecified user. It is possible to designate a user who has given permission to ascertain the user's driving situation to another user identified by the user's login ID. A user who gives permission to ascertain the user's driving situation and a permitted user are set in the user's key service settings.

The target ID included in the start request generated by the processor 401 in Step ST81 in FIG. 10 is the user ID of the user designated as the target of ascertainment of the driving situation.

On the other hand, in the case where the start request is received while the processor 101 of the server apparatus 100 is in the standby state in which the processor 101 repeats Steps ST11 to ST14 in FIG. 3, the processor 101 determines “Yes” in Step ST13 and proceeds to Step ST18.

In Step ST18, the processor 101 refers to the user DB and acquires analysis results and travel data that are associated with the target ID included in the start request received in Step ST13.

In Step ST19, the processor 101 generates a start response. The start response includes the analysis results and the travel data acquired in Step ST18, and the target ID included in the start request received in Step ST13. The start response is information instructing to display the analysis results and the travel data. After generating the start response, the processor 101 instructs the communication interface 105 to transmit the start response to the key terminal apparatus 200 or the terminal apparatus 400 from which the start request was transmitted. In response to the transmission instruction, the communication interface 105 transmits the start response to the key terminal apparatus 200 or the terminal apparatus 400. The transmitted start response is received by the communication interface 205 of the key terminal apparatus 200 or the communication interface 405 of the terminal apparatus 400. After performing the processing of Step ST19, the processor 101 returns to Step ST11.

By performing the processing of transmitting the start response to the key terminal apparatus 200, the processor 101 functions as an example of a display controller that causes the first terminal to display the driving situation by communicating with the first terminal. Alternatively, the processor 101 functions as an example of the display controller in cooperation with the communication interface 105. By performing processing of transmitting the start response to the terminal apparatus 400, the processor 101 functions as an example of a display controller that causes the second terminal to display the driving situation.

On the other hand, in Step ST82 in FIG. 7, the processor 201 of the key terminal apparatus 200 waits for the start response to be received by the communication interface 205. In response to reception of the start response, the processor 201 determines “Yes” in Step ST82 and proceeds to Step ST83.

In Step ST83, the processor 201 starts processing for the driving situation to be ascertained. To this end, the processor 201 causes the display device 207 to display an ascertainment screen, for example. The ascertainment screen contains, for example, the travel data and the analysis results included in the start response received in Step ST82. The ascertainment screen may be composed of a plurality of pages. The ascertainment screen may be scrollable.

The operator of the key terminal apparatus 200 ascertains the driving situation. That is, the operator sees the travel data and the analysis results displayed on the display device 207. To end the ascertainment of the driving situation, the operator performs, via the input device 407, an input indicating an instruction to end the ascertainment of the driving situation.

In Step ST84, the processor 201 waits for the instruction to end the processing for the driving situation to be ascertained. Specifically, the processor 201 waits for a predetermined operation, such as operation of a button for instructing to end the processing for the driving situation to be ascertained. In response to the operation for instructing to end the processing for the driving situation to be ascertained, the processor 201 determines “Yes” in Step ST84 and proceeds to Step ST85.

In Step ST85, the processor 201 determines whether or not the operator of the key terminal apparatus 200 has ascertained the driving situation. For example, in a case where the time taken for the operator to ascertain the driving situation is equal to or longer than a predetermined time, the processor 201 determines that the operator has ascertained the driving situation. The time taken for the operator to ascertain the driving situation is, for example, a time from the execution of the processing of Step ST83 to the determination of “Yes” in Step ST84. For example, in a case where a predetermined number of pages or all pages have been displayed on the ascertainment screen, the processor 201 determines that the operator has ascertained the driving situation. For example, in a case where a predetermined part or more or the entirety of the ascertainment screen has been scrolled, the processor 201 determines that the operator has ascertained the driving situation. The ascertainment screen may display a test about the driving situation. For example, in a case where the operator's test score is equal to or higher than a predetermined score, the processor 201 determines that the operator has ascertained the driving situation. The ascertainment screen may include a video. For example, in a case where the video has been played for a predetermined time or entirely, the processor 201 determines that the operator has ascertained the driving situation. Alternatively, the processor 201 may determine that the operator has ascertained the driving situation when a condition as a combination of the above-described conditions is satisfied. When the processor 201 does not determine that the operator has ascertained the driving situation, the processor 201 determines “No” in Step ST85 and returns to Step ST61 in FIG. 6. On the other hand, when the processor 201 determines that the operator has ascertained the driving situation, the processor 201 determines “Yes” in Step ST85 and proceeds to Step ST86.

The processor 201 may make a presumptive determination that the operator of the key terminal apparatus 200 has ascertained the driving situation without any particular condition. In this case, for example, when determining “Yes” in Step ST85, the processor 201 proceeds to Step ST86.

In Step ST86, the processor 201 generates an ascertainment notification. The ascertainment notification includes the login ID and the target ID, which was included in the start response received in Step ST82. The ascertainment notification is information indicating that the user identified by the login ID has ascertained the driving situation of the user identified by the target ID. After generating the ascertainment notification, the processor 201 instructs the communication interface 205 to transmit the ascertainment notification to the server apparatus 100. In response to this transmission instruction, the communication interface 205 transmits the ascertainment notification to the server apparatus 100. The transmitted ascertainment notification is received by the communication interface 105 of the server apparatus 100. After performing the processing of Step ST86, the processor 201 returns to Step ST61 in FIG. 6.

On the other hand, in the case where the ascertainment notification is received while the processor 101 of the server apparatus 100 is in the standby state in which the processor 101 repeats Steps ST11 to ST14 in FIG. 3, the processor 101 determines “Yes” in Step ST14 and proceeds to Step ST20.

In Step ST20 in FIG. 3, the processor 101 of the server apparatus 100 records, in the user DB, the date and time when the user identified by the login ID most recently ascertained the driving situation. For example, the processor 101 stores the current date and time in association with the login ID and the target ID included in the ascertainment notification received in Step ST14. The current date and time indicates a date and time when the user identified by the login ID ascertained the driving situation of the user identified by the target ID.

In Step ST21, the processor 101 determines whether or not to derestrict the digital key of the user identified by the target ID included in the ascertainment notification received in Step ST14. In a case where the user identified by the login ID included in the ascertainment notification received in Step ST14 is not the prespecified user pertaining to the driving user identified by the target ID, the processor 101 does not determine to derestrict the digital key. On the other hand, in a case where the user identified by the login ID is the prespecified user pertaining to the driving user identified by the target ID, the processor 101 refers to the user DB and checks the value of the server restriction variable associated with the target ID included in the ascertainment notification received in Step ST14. If the value indicates the unrestricted state, the processor 101 does not determine to derestrict the digital key. On the other hand, if the value indicates the restricted state, the processor 101 checks whether or not the failure to ascertain the driving situation of the user identified by the target ID within the time period has occurred. The processor 101 does not determine to derestrict the digital key in the case where the failure to ascertain the driving situation of within the time period has occurred. On the other hand, the processor 101 determines to derestrict the digital key in the case where the failure to ascertain the driving situation of within the time period has not occurred. When the processor 101 does not determine to derestrict the digital key, it determines “No” in Step ST21 and returns to Step ST11. When the processor 101 determines to derestrict the digital key, it determines “Yes” in Step ST21 and proceeds to Step ST22.

In Step ST22, the processor 101 updates the user DB to set the value of the server restriction variable associated with the target ID included in the ascertainment notification received in Step ST14 to a value indicating the unrestricted state.

In Step ST23, the processor 101 instructs the communication interface 105 to transmit a derestriction request to the key terminal apparatus 200 used by the user identified by the target ID included in the ascertainment notification received in Step ST14. The derestriction request is information instructing to release the digital key from the restricted state and bring the digital key into the unrestricted state. In response to the transmission instruction, the communication interface 105 transmits the derestriction request to the key terminal apparatus 200. The transmitted derestriction request is received by the communication interface 205 of the key terminal apparatus 200. After performing the processing of Step ST23, the processor 101 returns to Step ST11.

On the other hand, in the case where the derestriction request is received while the processor 201 of the key terminal apparatus 200 is in the standby state in which the processor 201 repeats Steps ST61 to ST68 in FIGS. 6 and 7, the processor 201 determines “Yes” in Step ST67 and proceeds to Step ST87 in FIG. 7.

In Step ST87, the processor 201 release the digital key from the restricted state and brings the digital key into the unrestricted state. To this end, the processor 201 rewrites the value of the restriction variable to a value indicating the unrestricted state.

In Step ST88, in order to notify the person who is holding the key terminal apparatus 200 that the digital key has been derestricted and brought into the unrestricted state, the processor 201 issues a notification to that effect. For example, the processor 201 causes the display device 207 to display an image indicating that the digital key has been derestricted and brought into the unrestricted state. Alternatively or additionally, the processor 201 may issue the notification by outputting sound from a speaker, causing a light-emitting device to emit light, causing a vibrator to vibrate, and a similar means. Alternatively or additionally, the processor 201 may issue the notification by a push notification. After performing the processing of Step ST88, the processor 201 returns to Step ST61 in FIG. 6.

In the following, operations of the key terminal apparatus 200 and the vehicle 300 when the digital key is in the restricted state will be described.

When the digital key is in the restricted state, the processor 201 of the key terminal apparatus 200 determines “Yes” in Step ST74 and proceeds to Step ST76.

In Step ST76, the processor 201 generates an unlock request. The value of a restriction variable included in the unlock request indicates the restricted state. After generating the unlock request, the processor 201 instructs the wireless interface 206 to transmit the unlock request to the vehicle 300. In response to this transmission instruction, the wireless interface 206 transmits the unlock request to the vehicle 300. The transmitted unlock request is received by the key interface 320 of the vehicle 300.

In Step ST77, in order to notify the person who is holding the key terminal apparatus 200 that the digital key is in the restricted state, the processor 201 issues a notification to that effect. For example, the processor 201 causes the display device 207 to display an image indicating that the digital key is in the restricted state and that the restricted state is cancelled if the driving situation is ascertained. Alternatively or additionally, the processor 201 may issue the notification by outputting sound from a speaker, causing a light-emitting device to emit light, causing a vibrator to vibrate, and a similar means. Alternatively or additionally, the processor 201 may issue the notification by a push notification. After performing the processing of Step ST77, the processor 201 returns to Step ST61.

On the other hand, when the digital key is in the restricted state, the processor 311 of the control apparatus 310 determines “Yes” in Step ST104 in FIG. 9 and proceeds to Step ST109.

In Step ST109, the processor 311 notifies the user of the digital key that the digital key is in the restricted state. The processor 311 issues the notification by voice or the like, for example.

In Step ST110, the processor 311 refers to the vehicle setting information and determines whether or not the electronic lock 331 is set to be unlocked when the digital key is in the restricted state. When the electronic lock 331 is set not to be unlocked when the digital key is in the restricted state, the processor 311 determines “No” in Step ST110 and returns to Step ST101. On the other hand, when the electronic lock 331 is set to be unlocked when the digital key is in the restricted state, the processor 311 determines “Yes” in Step ST110 and proceeds to Step ST104.

When the processor 311 proceeds from Step ST110 to Step ST106 and performs the processing of Step S103, the vehicle 300 is brought into a partially locked state from the locked state. The partially locked state is a state in which a part of the vehicle 300 is unlocked. The part includes at least the electronic lock 331. Therefore, the partially locked state is a state in which some or all of the components of the vehicle 300 cannot be started. It is preferable that the vehicle 300 in the partially locked state cannot travel. The partially locked state is one example of a state in which at least one function of the vehicle 300 is restricted.

When the digital key is in the restricted state, the processor 311 determines “Yes” in Step ST107 and proceeds to Step ST111.

In Step ST111, the processor 311 refers to the vehicle setting information and specifies a component and equipment that are set to be started even when the digital key is in the restricted state. The processor 311 then starts the operation of the specified component and equipment. However, the processor 311 preferably prevents the vehicle 300 from being able to travel. If there is no component or equipment other than the electronic lock 331 that is set to be started even when the digital key is in the restricted state, the processor 311 does not start the operation of any component or equipment in the processing of Step ST111. After the processing of Step ST111, the vehicle 300 remains in the partially locked state.

In Step ST112, the processor 311 waits for the key interface 320 to receive the unlock request. In response to reception of the unlock request, the processor 311 determines “Yes” in Step ST112 and proceeds to Step ST113.

In Step ST113, the processor 311 determines whether or not the digital key is in the restricted state with reference to the restriction variable included in the unlock request received in Step ST112. When the digital key is in the restricted state, the processor 311 determines “Yes” in Step ST113, and returns to Step ST112. On the other hand, when the digital key is in the unrestricted state, the processor 311 determines “No” in Step ST113 and proceeds to Step ST114.

In Step ST114, the processor 311 starts the components of the vehicle 300. After performing the processing of Step ST114, the processor 311 ends the processing illustrated in FIG. 9. As described above, when the digital key is switched from the restricted state to the unrestricted state, the vehicle 300 is switched from the partially locked state to the unlocked state.

When the operator of the key terminal apparatus 200 wants to bring the vehicle 300 into the locked state, the operator performs an operation of instructing the key terminal apparatus 200 to bring the vehicle 300 into the locked state via the input device 208. This operation may be allowed only when the vehicle 300 is the partially locked state or the unlocked state.

Alternatively, when the operator wants to bring the vehicle 300 into the locked state, the operator with the key terminal apparatus 200 leaves the vehicle 300.

In the case where the processor 201 of the key terminal apparatus 200 determines to bring the vehicle 300 into the locked state while being in the standby state in which the processor 201 repeats Steps ST61 to ST68 in FIGS. 6 and 7, the processor 201 determines “Yes” in Step ST68 in FIG. 7 and proceeds to Step ST89.

In Step ST89, the processor 201 generates a lock request. The lock request is information for requesting the vehicle 300 to be in the locked state. The lock request includes, for example, a login ID, a restriction variable stored in the auxiliary storage device 204, and key information registered in the key application. After generating the lock request, the processor 201 instructs the wireless interface 206 to transmit the lock request to the vehicle 300. In response to this transmission instruction, the wireless interface 206 transmits the lock request to the vehicle 300. The transmitted lock request is received by the key interface 320 of the vehicle 300. After performing the processing of Step ST89, the processor 201 returns to Step ST61.

On the other hand, when the lock request is received by the key interface 320, the processor 311 of the control apparatus 310 determines to bring the vehicle 300 into the locked state. In addition, when the key terminal apparatus 200 is separated from the vehicle 300 by a predetermined distance or more, the processor 311 determines to bring the vehicle 300 into the locked state.

In the case where the processor 311 of the control apparatus 310 determines to bring the vehicle 300 into the locked state while being in the standby state in which the processor 311 repeats Steps ST101 and ST102, the processor 311 determines “Yes” in Step ST102 and proceeds to Step ST115.

In Step ST115, the processor 311 brings the vehicle 300 into the locked state. Specifically, the processor 311 stops the components of the vehicle 300 that have been started in Steps ST108, ST111, and ST114. Further, the processor 311 controls and locks the electronic lock 331. After performing the processing of Step ST115, the processor 311 returns to Step ST101.

The digital key system 1 according to the embodiment brings the digital key into the restricted state when a driving user who uses the digital key satisfies a predetermined condition. With this feature, the digital key system 1 according to the embodiment can encourage the driving user not to satisfy the predetermined condition. If the predetermined condition includes a content related to the safe driving, the digital key system 1 of the embodiment can encourage the driving user to drive safely.

The digital key system 1 according to the embodiment causes the key terminal apparatus 200 functioning as a digital key to display the driving situation of the driving user. In addition, the digital key system 1 of the embodiment brings the digital key into the restricted state when the driving user has not ascertained the driving situation for the predetermined period P1 or longer. With this feature, the digital key system 1 according to the embodiment can prompt the driving user to ascertain the driving situation. When ascertaining the driving situation, the driving user is provided with an opportunity to look back their driving. Thus, the digital key system 1 of the embodiment can encourage the driving user to drive safely.

In a case where a remaining time until the failure to ascertain the driving situation within the time period occurs has become equal to or shorter than the predetermined period P2, the digital key system 1 of the embodiment causes the key terminal apparatus 200 or the terminal apparatus 400 to notify that the failure to ascertain the driving situation within the time period is likely to occur. With this feature, the digital key system 1 of the embodiment can notify the user that the failure to ascertain the driving situation within the time period is likely to occur and that the digital key is likely to be restricted.

In addition, the digital key system 1 according to the embodiment brings the digital key into the restricted state in a case where there is a problem in the user's driving. It is presumed that in consideration of this, the driving user drives such that the digital key will not be brought into the restricted state. In this way, the digital key system 1 of the embodiment can encourage the driving user to drive safely.

The digital key system 1 according to the embodiment is capable of causing the terminal apparatus 400, which is used by a user different from the driving user, to display the driving situation. Due to this feature, in a case where the different user is, for example, a family member of the driving user, the family member can be informed of the driving situation of the driving user. In a case where the different user is, for example, a rental car company that is going to rent a car to the driving user, the rental car company can be informed of the driving situation of the driving user before renting the car. The rental car company can also stop the provision of car rental when the driving situation is unsatisfactory.

The digital key system 1 according to the embodiment causes the terminal apparatus 400, which is used by a prespecified user different from the driving user, to display the driving situation of the driving user. Furthermore, the digital key system 1 according to the embodiment brings the digital key into the restricted state in a case where the prespecified user has not ascertained the driving situation for the predetermined period P1 or longer. In this way, the digital key system 1 according to the embodiment can prompt the family member of the driving user to ascertain the driving situation.

The digital key system 1 according to the embodiment stores the driving situation of the driving user. With this feature, the digital key system 1 of the embodiment can accumulate the driving situation of the driving user. Thus, the digital key system 1 of the embodiment is capable of performing a more accurate analysis of the driving situation.

According to the digital key system 1 of the embodiment, the digital key is used to unlock the electronic lock 331 of the door 330. Thus, the digital key system 1 according to the embodiment can prevent the driving user from driving, by restricting the digital key.

The digital key system 1 of the embodiment can unlock the electronic lock 331 even when the digital key is in the restricted state. In this case, even when the digital key is in the restricted state, the driving user can get into the vehicle 300. Thus, even when the digital key is in the restricted state, the driving user can remove luggage from the interior of the vehicle, take a break in the vehicle, and so

According to the digital key system 1 of the embodiment, even when the digital key is in the restricted state, it is possible to cause the vehicle 300 to start a part of the components and equipment of the vehicle 300 by operating the start button 360. In this case, even when the digital key is in the restricted state, the driving user can use, for example, a car audio system, an in-vehicle Wi-Fi system, a car navigation system, etc.

The above embodiment may be modified as follows. When the digital key is in the restricted state, the key terminal apparatus 200 does not need to transmit the unlock request. In this case, for example, when determining “Yes” in Step ST74, the processor 201 proceeds to Step ST77. In this case, the processor 311 of the control apparatus 310 does not need to determine whether or not the digital key is in the restricted state. That is, when determining “Yes” in Step ST103, the processor 311 proceeds to Step ST104. Then, when determining “Yes” in Step ST106, the processor 311 proceeds to Step ST108.

When the digital key is in the restricted state, the key terminal apparatus 200 does not need to establish connection to the key interface 320. In this case, for example, when determining “Yes” in Step ST63, the processor 201 proceeds to Step ST74. Then, when determining “Yes” in Step ST74, the processor 201 proceeds to Step ST77. On the other hand, when determining “No” in Step ST74, the processor 201 proceeds to Step ST73. After performing the processing of Step ST73, the processor 201 proceeds to Step ST75.

The control apparatus 310 may determine whether the digital key is in the restricted state by inquiring the server apparatus 100. In this case, the key terminal apparatus 200 does not need to determine whether or not the digital key is in the restricted state.

In the above embodiment, the vehicle 300 can be brought into the locked state regardless of whether the digital key is in the restricted state or not. However, when the digital key is in the restricted state, the vehicle 300 may be prevented from being brought into the locked state. In this case, for example, when the digital key is in the restricted state, the processor 201 of the key terminal apparatus 200 does not transmit the lock request. Alternatively, the processor 311 of the control apparatus 310 determines whether or not the digital key is in the restricted state with reference to the restriction variable included in the received lock request. When the digital key is in the restricted state, the processor 311 does not bring the vehicle 300 into the locked state. Whether to bring the vehicle 300 into the locked state when the digital key is in the restricted state may be changeable by setting. This setting is stored in the auxiliary storage device 314 as vehicle setting information. Furthermore, it may be possible to set a component and equipment to be lockable even in the restricted state. In this case, when the lock request is received, the processor 311 refers to the vehicle setting information and locks the component and equipment that are set to be lockable even in the restricted state. In other words, the processor 311 stops the component and equipment that are set to be lockable even in the restricted state, from among the components of the vehicle 300 that have been started in Step ST108, ST111, or ST114. In a case where the electronic lock 331 is set to be lockable even in the restricted state, the processor 311 controls and locks the electronic lock 331. A component and equipment may be set to be started even when the digital key is in the restricted state by the same setting as the setting for the component and equipment set to be lockable even in the restricted state, so that the former component and equipment and the latter component and equipment are the same, for example.

The predetermined condition may be a condition different from that described above.

The digital key system of the embodiment may restrict the functions of the vehicle itself instead of bringing the digital key into the restricted state.

In the above-described embodiment, the digital key system 1 has been described with reference to the example in which the digital key system 1 is applied to the vehicle 300 that is an automobile. However, the digital key system of the embodiment is also applicable to a mobile body other than automobiles. Examples of the mobile body other than automobiles include a railcar, an aircraft, a ship, a submarine, a spacecraft, etc. Furthermore, the digital key system according to the embodiment may be applied to a remotely driven (remotely operated) mobile body. The digital key system 1 of the embodiment is also applicable to a machine other than mobile bodies. Examples of the machine other than mobile bodies include a fixed crane, etc. The digital key system of the embodiment applied to a machine other than automobiles includes, instead of the door 330, a door to a place for driving (manipulating) the machine, such as a driver's seat (cockpit seat), a control room (cockpit), etc. The door is provided with an electronic lock 331, likewise to the door 330. In the case of a remotely operated machine, the place for operating the machine is located outside the machine. In the case of a machine other than a remotely operated machine, the place for operating the machine is located inside the machine.

A part of the processing performed by the server apparatus 100 in the above embodiment may be performed by the key terminal apparatus 200, the control apparatus 310, or the terminal apparatus 400. A part of the processing performed by the key terminal apparatus 200 in the above embodiment may be performed by the server apparatus 100 or the control apparatus 310. A part of the processing performed by the control apparatus 310 in the above embodiment may be performed by the Server apparatus 100 or the key terminal apparatus 200. A part of the processing performed by the terminal apparatus 400 in the above embodiment may be performed by the server apparatus 100.

The processor 101, the processor 201, the processor 311, and the processor 401 may perform part or all of the processing, which is performed based on the programs in the above-described embodiment, by means of a hardware configuration of circuitry.

The program for performing the processing of the embodiment is transferred while being stored in a non-transitory storage medium incorporated in an apparatus, for example. However, the apparatus may be transferred in a state in which the program is not stored. The program may be separately transferred and written to the apparatus. In this case, for example, the program can be transferred by being recorded in a removable non-transitory storage medium or by being downloaded via a network such as the Internet or a LAN.

It should be noted that the above embodiment of the present invention has been described by way of example only, and is not intended to limit the scope of the present invention. The embodiment of the present invention can be implemented in various modes without deviating from the spirit of the present invention.

### EXPLANATION OF REFERENCE NUMERALS

1: Digital key system
100: Server apparatus
101, 201, 311, 401: Processor
102, 202, 312, 402: ROM
103, 203, 313, 403: RAM
104, 204, 314, 404: Auxiliary storage device
105, 205, 315, 405: Communication interface
106, 209, 317, 408: Bus
200: Key terminal apparatus
206: Wireless interface
207, 406: Display device
208, 407: Input device
300: Vehicle
310: Control apparatus
316: Control interface
320: Key interface
330: Door
331: Electronic lock
340: Drive unit
350: Electrical equipment
360: Start button
400: Terminal apparatus

1. An information management apparatus, comprising:
a communicator that communicates with a first terminal that is used as a digital key for restricting and/or derestricting at least one function of a machine,
a determiner that determines whether a first user who uses the first terminal satisfies a predetermined condition; and
a restrictor that brings, in a case where the predetermined condition is satisfied, the digital key into a restricted state in which the digital key is unable to restrict and/or derestrict the at least one function.

2. The information management apparatus according to claim 1, further comprising,
an acquirer that acquires information indicating an operation situation of the machine by the first user; and
a display controller that causes the first terminal to display the operation situation, by communicating with the first terminal, wherein
the predetermined condition is that the first user has not ascertained the operation situation for a first predetermined period or longer.

3. The information management apparatus according to claim 2, further comprising:
a notification controller that causes the first terminal to notify that the predetermined condition is likely to be satisfied, in a case where a remaining time until an amount of time during which the first user has not ascertained the operation situation becomes equal to the first predetermined period or longer is equal to or shorter than a second predetermined period.

4. The information management apparatus according to claim 1, wherein the determiner determines that there is a problem in operation of the machine by the first user, as the predetermined condition.

5. The information management apparatus according to claim 1, further comprising:
an acquirer that acquires an operation situation of the machine by the first user; and
a display controller that causes a second terminal to display the operation situation, the second terminal being used by a second user different from the first user.

6. The information management apparatus according to claim 5, wherein the predetermined condition is that the second user has not ascertained the operation situation for a first predetermined period or longer.

7. The information management apparatus according to claim 2, further comprising a storage that stores therein the operation situation.

8. The information management apparatus according to claim 1, wherein
the at least one function includes locking a door that allows entry to a place for operating the machine, and
in the case where the predetermined condition is satisfied, the restrictor brings the digital key into the restricted state in which the digital key is unable to unlock the door.

9. A non-transitory computer-readable medium storing a program for causing a processor included in an information management apparatus equipped with a communicator to function as:
a communication controller that controls and causes the communicator to communicate with a first terminal that is used as a digital key for restricting and/or derestricting at least one function of a machine;
a determiner that determines whether a first user who uses the first terminal satisfies a predetermined condition; and
a restrictor that, in a case where the predetermined condition is satisfied, brings the digital key into a restricted state in which the digital key is unable to restrict and/or derestrict the at least one function.

10. A first terminal apparatus that constitutes a digital key system in cooperation with an information management apparatus,
the information management apparatus including: a communicator that communicates with the first terminal apparatus that is used as a digital key for restricting and/or derestricting at least one function of a machine; a determiner that determines whether a first user who uses the first terminal apparatus satisfies a predetermined condition; and a restrictor that brings, in a case where the predetermined condition is satisfied, the digital key into a restricted state in which the digital key is unable to restrict and/or derestrict the at least one function,
the first terminal apparatus comprising:
a digital key unit that causes the first terminal apparatus to function as the digital key; and,
a restriction storage that stores therein information indicating that the digital key is in the restricted state in accordance with control by the restrictor.

11. A non-transitory computer-readable medium storing a program for a processor included in a first terminal that is equipped with a storge and constitutes a digital key system in cooperation with an information management apparatus,
the information management apparatus including: a communicator that communicates with the first terminal that is used as a digital key for restricting and/or derestricting at least one function of a machine; a determiner that determines whether a first user who uses the first terminal satisfies a predetermined condition; and a restrictor that brings, in a case where the predetermined condition is satisfied, the digital key into a restricted state in which the digital key is unable to restrict and/or derestrict the at least one function,
the non-transitory computer-readable medium storing the program being configured to cause the processor to function as:
a digital key unit that causes the first terminal to function as the digital key; and,
a restriction storage that stores therein information indicating that the digital key is in the restricted state in accordance with control by the restrictor.

12. An information management method, comprising:
communicating with a first terminal that is used as a digital key for restricting and/or derestricting at least one function of a machine;
determining whether a first user who uses the first terminal satisfies a predetermined condition; and
in a case where the predetermined condition is satisfied, bringing the digital key into a restricted state in which the digital key is unable to restrict and/or derestrict the at least one function.
